(19) United States
(12) Patent Application Publication
(10) Pub. No.: US 2026/0123749 A1
(43) Pub. Date: May 7, 2026

(54) ARRANGEMENT FOR FITTING TOGETHER A BASIC STRUCTURE, BASIC STRUCTURE COMPRISING SUCH AN ARRANGEMENT AND ALSO METHOD FOR FITTING TOGETHER A BASIC STRUCTURE

(71) Applicant: Julius Blum GmbH, Hoechst (AT)

(72) Inventors: Olaf ISELE, Lustenau (AT); Emanuel NETZER, Hoechst (AT)

(21) Appl. No.: 19/441,348

(22) Filed: Jan. 6, 2026

Related U.S. Application Data
(63) Continuation of application No. PCT/AT2024/060251, filed on Jun. 26, 2024.

(30) Foreign Application Priority Data
Jul. 13, 2023 (AT) A 50553/2023

(51) Int. Cl. A47B 96/14; A47B 55/00

(52) U.S. Cl. CPC A47B 96/1466; A47B 55/00

(57) ABSTRACT

An arrangement is provided for assembling a body construction, in particular a base cabinet. At least four vertical supports each include a first fastening device for tool-free assembly of at least one first surface element parallel to the vertical support, and at least one second fastening device for tool-free assembly of at least one second surface element transverse to the vertical support.

The present application is a continuation of International Application PCT/AT2024/060251 filed on Jun. 26, 2024. Thus, all of the subject matter of International Application PCT/AT2024/060251 is incorporated herein by reference.

### BACKGROUND OF THE INVENTION

The present invention relates to an arrangement for assembling a body construction, in particular for a base cabinet, a body construction comprising such an arrangement, and a method for assembling a body construction.

The prior art will be explained hereinafter on the basis of a base cabinet. This generally applies analogously for body constructions.

Forming base cabinets from multiple surface elements is known from the prior art, wherein the surface elements form the side walls, the bottom, the rear wall, the cover panel, and possibly intermediate elements. In known embodiments of the prior art, these surface elements are connected to one another via fastening elements. Such fastening elements are usually angles which are screwed into the surface elements to connect them to one another. Other designs of connecting elements which are manufactured in the surface elements are well known.

However, in corresponding embodiments, the fastening elements for connecting the individual surface elements are always screwed, incorporated, and/or inserted into the surface elements themselves, due to which the surface elements have to have sufficient rigidity not only to withstand the environmental stresses, but also be able to accommodate the fastening elements.

Furthermore, these accommodated fastening elements, which are usually screwed into the surface elements, form weak points, so that under heavy load the cross section of the surface elements is weakened at the point of screwing in or incorporating the fastening elements and usually results in breakage or damage at this point (in the case of an inadequate, solid design of the surface element).

Another disadvantage is that quite a large amount of energy and time has to be expended in the manufacturing and assembly to incorporate corresponding receptacle holes and receptacle openings in the surface elements and/or to measure and/or provide positions for accommodating the fastening elements. Furthermore, each individual surface element has to be specifically prepared for its later use and also has to be assigned to the later area of use, which in turn results in increased logistical effort.

In summary, it can be stated that for a base cabinet, individual surface elements have to be prepared quite specifically for later assembly, have to be individually processed logistically for transport to the area of use, and at the area of use, they have to be positioned by specialists in a targeted and individual manner relative to the respective other surface elements and connected to one another via the fastening elements.

The desire results therefrom with respect to a simpler option for producing a base cabinet, which not only can reduce the manufacturing after, but can also minimize the logistical challenge and possibly even facilitate the assembly work.

### SUMMARY OF THE INVENTION

The object of the present invention is therefore to implement an arrangement for assembling a body construction, a body construction, and a method for assembling a body construction, with the aid of which the manufacturing effort can be reduced and/or the assembly work can be facilitated or reduced and/or the logistics work for transport can be reduced and/or the environmental aspect can be improved by reducing transport masses or reducing the materials required.

According to the invention, an arrangement for assembling a body construction, in particular a base cabinet, has at least four vertical supports, each comprising a first fastening device for tool-free assembly of at least one first surface element parallel to the vertical support and at least one second fastening device for tool-free assembly of at least one second surface element transverse to the vertical support. By providing appropriate vertical supports which enable the tool-free assembly of the surface elements, the option is provided of connecting surface elements to one another without separate holes or receptacle openings via the vertical supports and their fastening devices. Accordingly, the surface elements can be designed in such a way that they have smaller cross-sectional areas, since these cross-sectional areas are no longer weakened by holes and/or openings for fastening.

Reducing the size of the surface elements has the advantage that less material expenditure is required for the surface elements, which also results in a transport advantage, since less mass has to be transported, resulting in a significant overall improvement in the environmental and ecological aspects.

On the other hand, it is no longer necessary to design the surface elements having openings and/or holes or other elements for fastening, which reduces the manufacturing effort for the prefabrication of the surface elements to a minimum (the cutting).

Furthermore, an improvement is created in that surface elements no longer have to be assigned exactly to their later use. Thus, a surface element no longer has to be assigned to, for example, a left or a right side of the body construction, since these components can be manufactured identically, which also reduces the logistical effort for transport, manufacturing, and assembly.

Furthermore, it is possible to implement tool-free assembly via the vertical supports, which reduces the assembly effort and the complexity of the assembly. The vertical supports can also stiffen the body construction, which permits an additional reduction of the material expenditure and the dimensions of the surface elements.

Furthermore, the option is provided of implementing a very high degree of prefabrication via the vertical elements. For example, the vertical elements—as will be described in more detail later—can be equipped with elements such as electrical shafts, receptacle elements for fitting bodies or also base feet, electrifications or fastening points for screens, which do not need to be additionally installed during assembly, thus simplifying the assembly considerably.

Furthermore, storage space can be gained by reducing the dimensions of the surface elements, wherein the interior of the body construction is increased while maintaining the same external dimensions. In other words, available space can be used more efficiently, thus creating storage space.

The vertical supports can each include at least one interface for—preferably tool-free—fastening of at least one furniture fitting, preferably a pullout guide for a drawer, preferably transversely to the vertical support.

Preferably, two of the at least four vertical supports each have at least one first interface for fastening at least one furniture fitting, and the other two of the at least four vertical supports each have at least one second interface for fastening at least one furniture fitting. The first and the second interface are designed differently, particularly preferably wherein the first and the second interface are arranged essentially rotated by 90° in relation to one another.

At least one furniture fitting can be provided, preferably a pullout guide for a drawer, which:
is connected to at least one of the vertical supports by at least one fastening means, preferably which cooperates with a fastening opening of the furniture fitting, and/or
is connected to at least one of the vertical supports by at least one connecting element, preferably wherein the at least one connecting element engages in an interface of at least one of the vertical supports.

For example, a screw element used as a fastening means can be screwed through a fastening opening of the furniture fitting into the vertical support, preferably into a threaded element provided for this purpose in the vertical support, in order to connect the furniture fitting to the vertical support.

The furniture fitting, preferably a pullout guide for a drawer, can have at least one interface for, preferably tool-free, fastening to at least one vertical support, wherein in particular the at least one vertical support has at least one connecting element which engages in the at least one interface.

The first fastening device and/or the second fastening device is or are releasably connected to one of the vertical supports. Preferably, the first fastening device and/or the second fastening device is or are connected to the vertical support by a formfitting and/or friction-locked connection, particularly preferably a screw and/or plug connection.

Preferably, the first fastening device comprises a groove along a longitudinal extension on at least one of the vertical supports, wherein the first surface element is positionable in the groove parallel to the vertical support.

The first fastening device can furthermore comprise a retaining element arranged or arrangeable in the groove, which retaining element is preferably formed by a formfitting connection, particularly preferably by a barbed geometry, to secure the first surface element positioned in the groove.

Preferably, the first fastening device has a positioning element for positioning the first surface element in relation to at least one of the vertical supports, preferably wherein the positioning element includes at least one spring element.

The second fastening device can have at least one engagement element, which engagement element is designed to engage in the second surface element for securing the position, preferably to implement a formfitting connection to the second surface element.

For example, at least one engagement element is formed hooked and is intended to penetrate into the second surface element and hook into it.

Preferably, the at least one engagement element has a tensioning element, preferably a spring element, which pre-tensions the engagement element in relation to the second surface element. The tensioning element can be operable, preferably releasable, by an actuating element.

Preferably, at least two of the vertical supports each have a further second fastening device for fastening a cross member connecting the two vertical supports.

The further second fastening element for tool-free fastening of the cross member can have a clamping device, which clamping device is preferably designed to exert a clamping force on the cross member via an eccentrically mounted lever.

At least one of the surfaces of the further second fastening device to be connected to the cross member can have projections, which projections preferably form into the cross member under the application of the clamping force and/or form a formfitting connection with the cross member to secure the position of the cross member.

Preferably, a second fastening device is arranged or arrangeable in each case at a first end and an opposite second end of at least one vertical support, preferably wherein the two second fastening devices have a distinguishable design.

At least one first fastening device can be arranged or arrangeable on at least one longitudinal side of at least one vertical support.

Preferably, at least one, preferably all, of the vertical supports is or can be assembled from at least two parts, and preferably the at least two parts are connectable to one another without tools.

The parts can be connectable to one another by a plug-in system, wherein the parts can be secured in position with one another, for example, by means of a click connection and/or a screw connection. Securing the position of the parts by way of the first or second surface element arranged on the vertical support is also quite conceivable.

The vertical support is or can be constructed from a large number of parts, so that the longitudinal extension of the vertical support can be chosen or extended as desired by the number of parts.

At least one, and preferably all, of the vertical supports can have at least one connection interface for connecting the vertical supports to an outer cover element and/or for directly connecting the vertical support to a vertical support of a further body construction.

The connection interface can have at least one connecting groove in a vertical support. A connecting element can be inserted into the connecting groove in order to connect the vertical support to an outer cover element and/or a vertical support of another body construction.

Preferably, the connecting elements are:
connected to or integrally formed with the outer cover element and/or the vertical support of the further body construction, or
designed as a separate component and is also mounted on the outer cover element and/or on the vertical support of the further body construction by a connecting groove.

Furthermore, protection is sought for a body construction, in particular a base cabinet, which body construction is formed from at least one arrangement according to the invention, wherein the at least four vertical supports are arranged essentially parallel to one another and on the vertical edges of a cuboid and are connected to one another via surface elements which are arranged parallel or transverse to the vertical supports.

In each case, two adjacent vertical supports can be connected to one another via at least one furniture fitting.

Preferably, at least one—in particular all—of the provided surface elements is or are formed:
by essentially flat surface elements,
by a metal, plastic, and/or wooden material, preferably a chipboard, and/or
having a wall thickness of 1 to 15 mm, preferably 5 to 13 mm, particularly preferably 7 to 10 mm.

Furthermore, protection is sought for a method for assembling a body construction, in particular a base cabinet, by at least one arrangement according to the invention, wherein the method comprises the following method steps:
two of the at least four vertical supports are connected to one another via at least one first surface element parallel to the vertical supports or via at least one second surface element transverse to the vertical supports, wherein in each case the at least one first surface element is installed on the vertical support without tools by means of the first fastening device or the at least one second surface element is installed on the vertical support without tools by means of the second fastening device, and
the other two of the at least four vertical supports are connected to the two previously connected vertical supports via further surface elements parallel or transverse to the vertical supports, so that the at least four vertical supports are arranged essentially parallel to one another on the vertical edges of a cuboid.

Preferably, in a further method step, in each case two adjacent vertical supports are connected to one another via at least one furniture fitting, preferably a pullout guide for a drawer, preferably transversely to the vertical supports.

### BRIEF DESCRIPTION OF THE DRAWINGS

Further details and advantages of the invention will be explained in more detail hereinafter with reference to the drawings, in which:

FIG. 1 shows an exemplary embodiment of a body construction according to the invention,

FIG. 2 is an exploded view of the exemplary embodiment of FIG. 1,

FIG. 3 is an isolation view of a first surface element with two vertical supports,

FIG. 4 is an exploded view of a vertical support,

FIG. 5 shows a second fastening device in an exploded view,

FIG. 6 shows a connection between a vertical support and a first surface element,

FIGS. 7, 8 show view A indicated by FIG. 6,

FIG. 9 shows a positioning of a retaining element on a vertical support,

FIG. 10 shows a connection between a vertical support and a second surface element,

FIGS. 11, 12 show different embodiments of detail view B from FIG. 10,

FIG. 13 shows an alternative procedure to FIG. 10,

FIG. 14 shows different details of the body construction,

FIGS. 15-17 show detail view C indicated in FIG. 14,

FIG. 18 shows detail view D indicated in FIG. 14,

FIG. 19 shows a connection between a vertical support and a pullout guide,

FIG. 20 is a detailed view of a pullout guide,

FIG. 21 shows another variant of a body construction,

FIGS. 22, 23 show different cross-sections of a vertical support,

FIGS. 24, 25 show a connection interface between two vertical supports, and

FIGS. 26, 27 show a connection interface of a vertical support to a cover element.

### DETAILED DESCRIPTION OF THE INVENTION

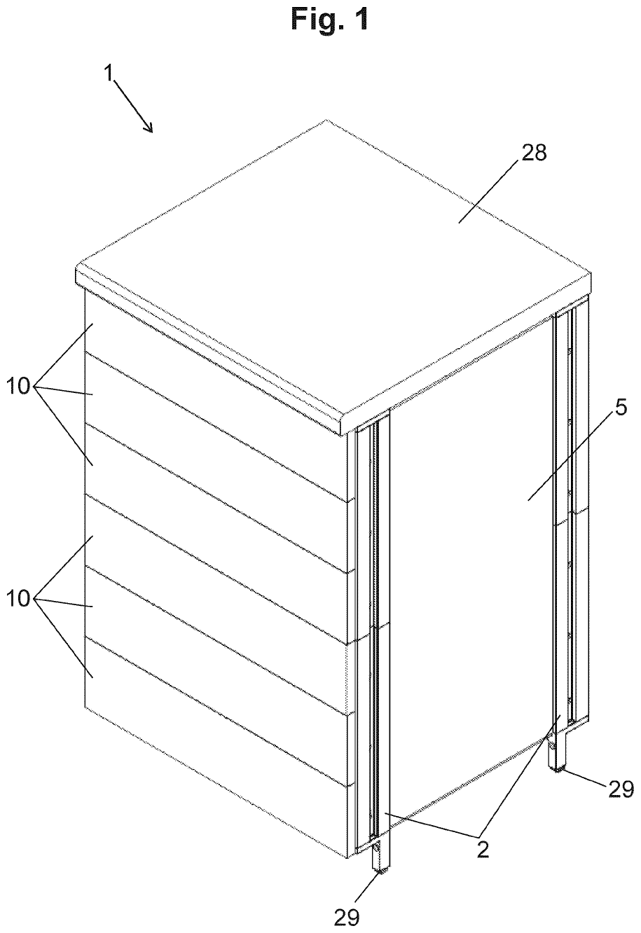

FIG. 1 shows an exemplary embodiment of a body construction 1 according to the invention, wherein in this exemplary embodiment the body construction 1 is designed as a base cabinet.

The body construction 1 comprises four vertical supports 2, which essentially form the vertical edges of a cuboid. The vertical supports 2 connect the first surface elements 5, by which the body construction 1 is implemented. The worktop 28 is placed above the body construction 1, and the body construction 1 is supported in relation to the floor on feet 29, which are arranged at a lower end of the vertical supports 2.

Six drawers 10, which are extendable by the pullout guides 9 relative to the body construction 1, are arranged in the interior of the body construction via pullout guides 9, which are arranged on the vertical supports.

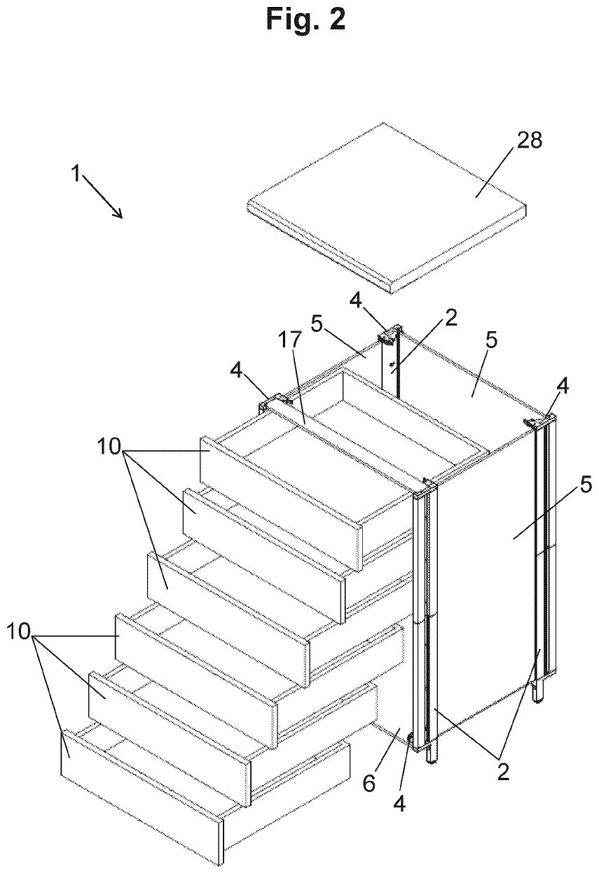

FIG. 2 shows an exploded view of the exemplary embodiment of FIG. 1. As can be seen from FIG. 2, the first surface elements 5, which are arranged parallel to the vertical supports 2, are connected to the vertical supports 2 via the second fastening devices 4. A second surface element 6, which is arranged essentially transversely to the vertical supports 2, is supported by the vertical supports 2 via the first fastening device 3.

In addition, each two vertical supports 2 are connected to one another via the further second fastening devices 4 using connected cross members 17 in order to increase the stability of the body construction 1.

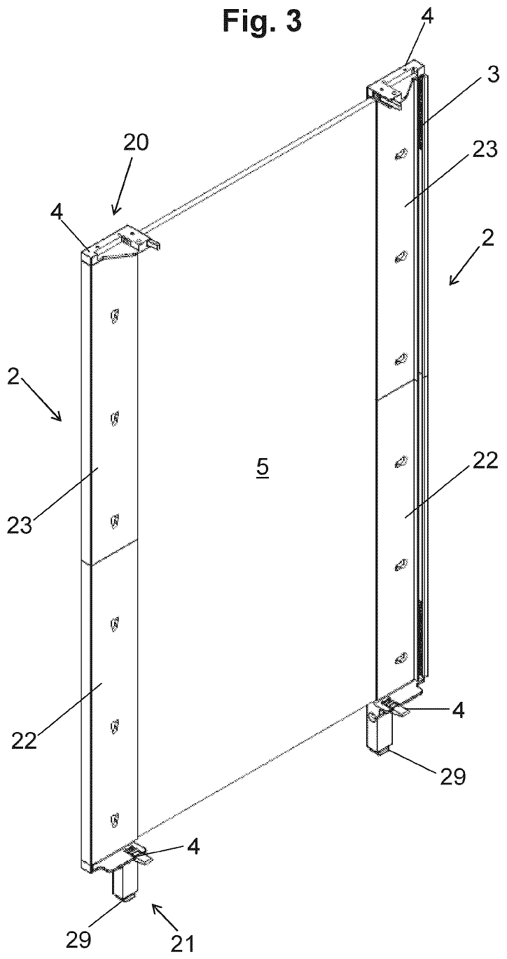

FIG. 3 shows a connection of two vertical supports 2 to a first surface element 5 in isolation, wherein the exact fastening of the first surface element 5 to the vertical supports 2 with the aid of the second fastening devices 4 will be explained in detail later. As can be seen from FIG. 3, the vertical supports 2 are composed of two parts 22, 23, wherein the two parts 22, 23 are connectable to one another without tools.

These vertical supports 2 furthermore comprise a second fastening device 4 in each case at a first end 20 and an opposite second end 21, wherein the two second fastening devices 4 are designed to have different constructions from one another.

In addition, the second fastening devices 4 arranged at the ends 20, 21 are connectable to the vertical support 2 without tools via plug connections, as will be explained in more detail in the following figure. The second fastening device 4 arranged at the second end 21 is furthermore connected to the foot 29.

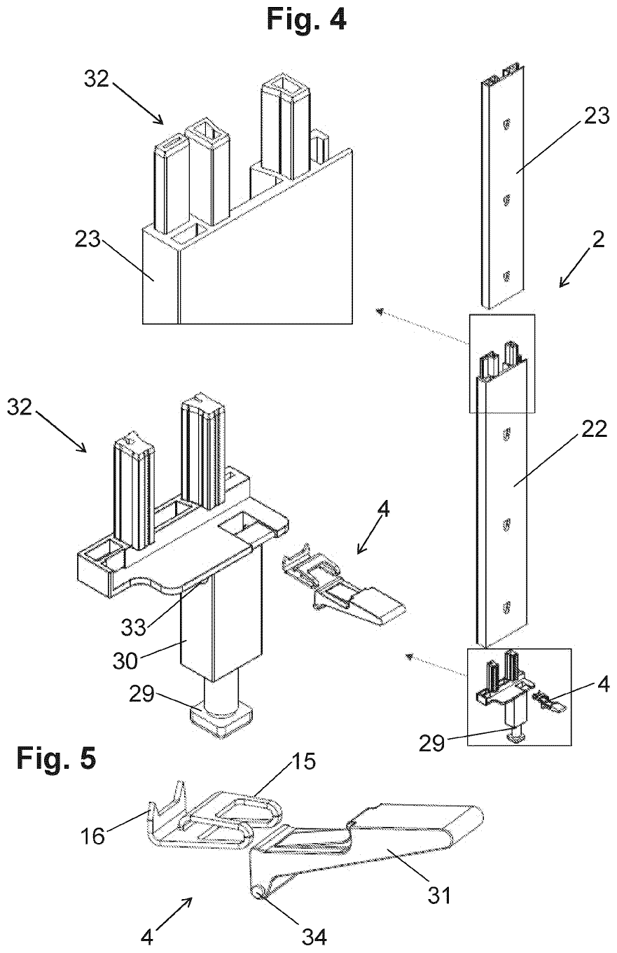

FIG. 4 shows an exploded view of a vertical support 2, from which it can be seen in greater detail that the vertical support 2 is formed by the two parts 22, 23, which are connected to one another along the longitudinal axis of the vertical support 2 by means of a plug-in system 32.

By appropriately designing the vertical support 2 made up of multiple parts 22, 23, a system can be implemented which allows a light, modular extension of the vertical support 2 and thus of the body construction 1, wherein, depending on the required length of the vertical support 2, the vertical support 2 can be lengthened or shortened by adding or removing a part 22, 23.

The plug-in system 32, which is shown in detail in FIG. 4, is designed such that protruding pins of the lower part 22 engage in a corresponding recess of the upper part 23, thereby positioning and aligning it along the longitudinal extension of the vertical support 2. This plug-in system 32 can be designed via appropriate dimensional tolerances (such as a press fit) such that the parts 22, 23 are connectable to one another via the insertion and can also be retained via the plug-in system 32. Alternatively, in the area of the plug-in system 32, the first part 22 and the second part 23 are connected to one another via a connecting bolt or a screw connection.

A suitable clamping connection is also quite conceivable. However, it is also conceivable that the first part 22 is simply inserted into the second part 23, and that the parts 22, 23 are then secured in position relative to one another by connecting the vertical support 2 to a first surface element 5 with the aid of the first fastening device 3 (such a connection will be explained in more detail in the following figures).

The second fastening device 4, which is arranged at the lower end of the part 22, is also held on the part 22 by means of a corresponding plug-in system 32. The second fastening device 4 (shown in greater detail in FIG. 5) comprises a base body 30.

FIG. 5 shows the second fastening device 4 in detail in an exploded view, and the foot 29 is also mounted on this base body 30. More precisely, the foot 29 is designed by its mounting in the base body 30 in such a way that the foot 29 can be moved via an adjustment element 33 for variable height adjustment in relation to the base body 30. This height adjustment of the foot 29 can be carried out, for example, via the adjustment element 33, wherein the adjustment element 33 can be rotated, for example, by means of a screwdriver or the like, wherein in turn a change in the relative position of the foot 29 to the base body 30 can be implemented, for example, via a gear-rack system.

The second fastening device 4 is also mounted on the base body 30. This fastening device 4 comprises an engagement element 16, which engagement element 16 is pre-tensioned by the spring element 15 against a second surface element 6, so that the engagement element 16—more precisely the hooks of the engagement element 16—as soon as the second surface element 6 is positioned on the second fastening device 4, are pressed into the second surface element 6 via the spring element 15 for the formfitting connection, by which these hooks of the engagement element 16 are anchored in the second surface element 6.

In order to be able to release this formfitting connection between the engagement element 16 and the second surface element 6, the engagement element 16 can be released via the actuating element 31, wherein a rotational movement of the actuating element 31, which is designed as a lever, around the rotational bearing 34 on the base body 30 tensions the spring element 15, causing the engagement element 16 to release or retract from the second surface element 6.

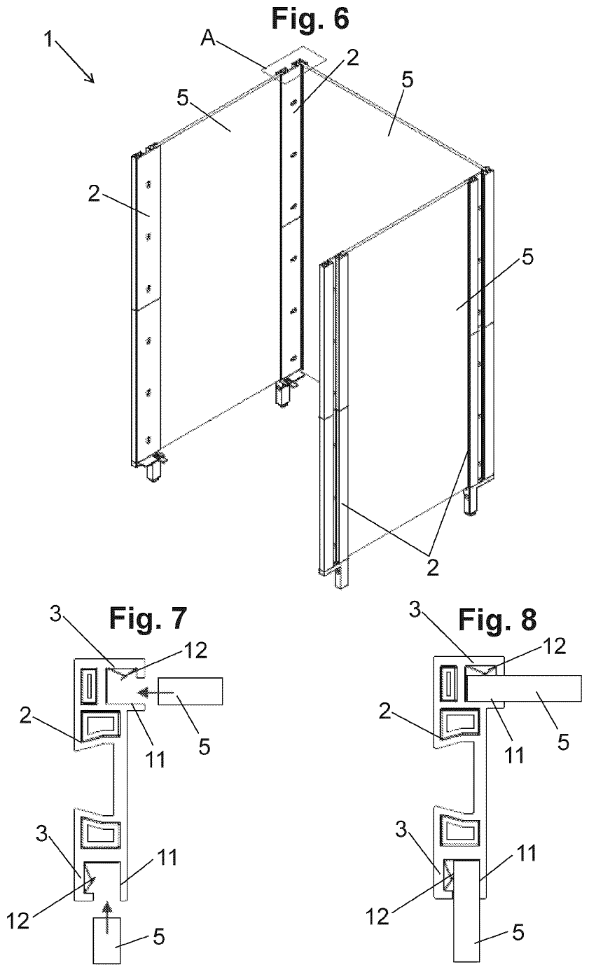

FIG. 6 shows an arrangement of the body construction 1 made up of the vertical supports 2 and the first surface elements 5, wherein a connection between the first surface elements 5 and the vertical supports 2 is implemented via the first fastening devices 3.

These first fastening devices 3 can be seen in greater detail in FIGS. 7 and 8, wherein FIG. 7 shows a state of the vertical support 2 before the first surface elements 5 are inserted and FIG. 8 shows a state of the vertical support 2 in which the vertical support 2 is connected to the first surface elements 5 via the first fastening devices 3.

FIGS. 7 and 8 show that the vertical support 2 has two first fastening devices 3 in each case, so that the vertical support 2 can be connected to two first surface elements 5 or can connect these two first surface elements 5 to one another.

The first fastening devices 3 each have a groove 11 along the longitudinal extension of the vertical support 2, wherein the first surface element 5 is positionable in the groove 11 parallel to the vertical support 2 in each case. Furthermore, the retaining elements 12 of the first fastening device 3 are arranged in the groove 11 of the vertical supports 2. These retaining elements 12 form a formfitting connection to the first surface elements 5 due to their barbed geometry 13 (which is explained in more detail in the following figures) in order to hold the first surface elements 5 in the grooves 11.

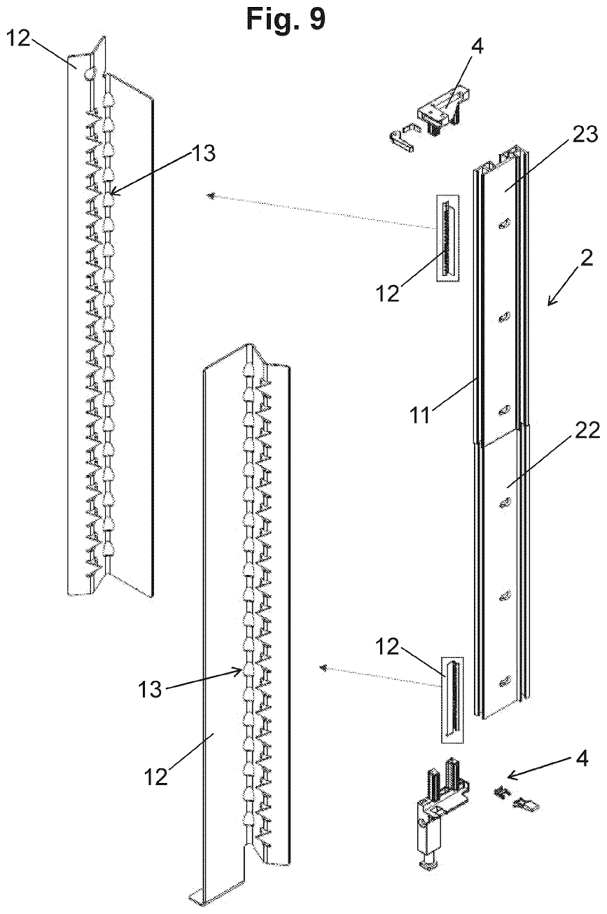

In this exemplary embodiment, the retaining elements 12 are elastically deformed when the first surface elements 5 are inserted in order to be able to position the surface element 5 in the groove 11. However, this elastic deformation of the retaining elements 12 causes the barbed geometry 13 to be pressed into the first surface elements 5 and thus position and/or hold the surface elements 5 relative to the vertical supports 2 in the groove 11. A corresponding design and positioning of the retaining elements 12 with their barbed geometry relative to a vertical support 2—more precisely: in the groove 11 of the vertical support 2—is shown in FIG. 9.

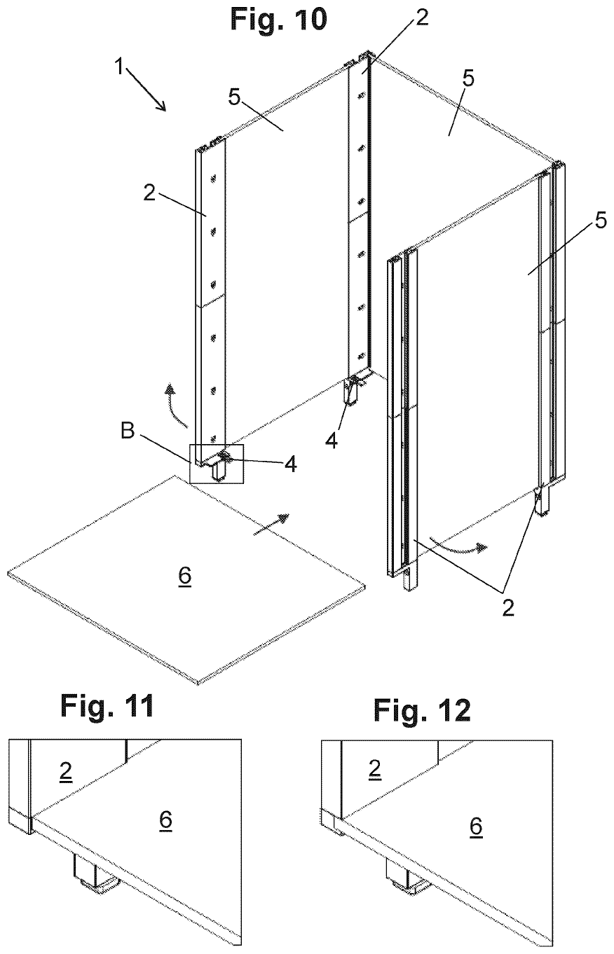

FIG. 10 shows a connection between the vertical supports 2 and a second surface element. It can be seen in FIG. 10 that the vertical supports 2 were first connected to the first surface elements 5 via the first fastening devices 3, and now this basic structure is subsequently connected to the second surface element 6 via the vertical supports 2.

For this purpose, as shown by the arrows, the two outer freestanding vertical supports 2 and the first surface elements 5 connected to them are first pulled apart, which is made possible by the still existing, somewhat fragile basic structure. This pulling apart makes it possible to insert the second surface element 6 from the front, which also enables the positioning of the second surface element 6 on the four vertical supports 2 and the second fastening devices 4 connected thereto.

By contacting the second surface element 6 with the second fastening devices 4 (which are already known from the preceding figures), the second surface element 6 is connected to the vertical supports 2 by the engagement elements 16 engaging in the second surface element 6. By contacting the vertical supports 2 or the second fastening devices 4 with the second surface element 6, the previously somewhat fragile construction is stabilized, by which a stable body construction 1 is implemented.

FIGS. 11 and 12 show two different exemplary embodiments of detail view B indicated in FIG. 10, wherein the front edge of the second surface element 6 can be covered by a cover element (see FIG. 11) or (see FIG. 12) can be free to protrude forward.

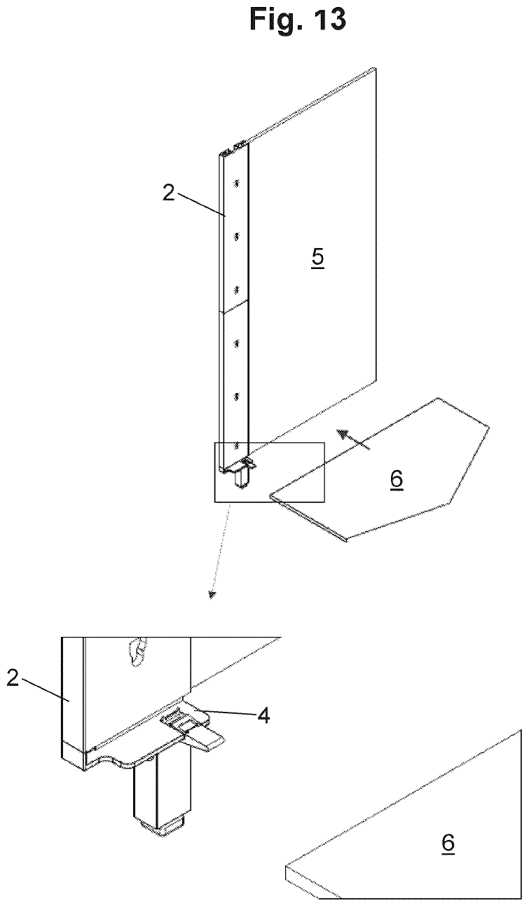

FIG. 13 shows an alternative procedure to FIG. 10. This figure shows an embodiment, wherein a first surface element 5 is first connected to a vertical support 2 and immediately following this method step, the second surface element 6 is already connected to the first surface element 5 via the second fastening device 4 of the vertical support 2.

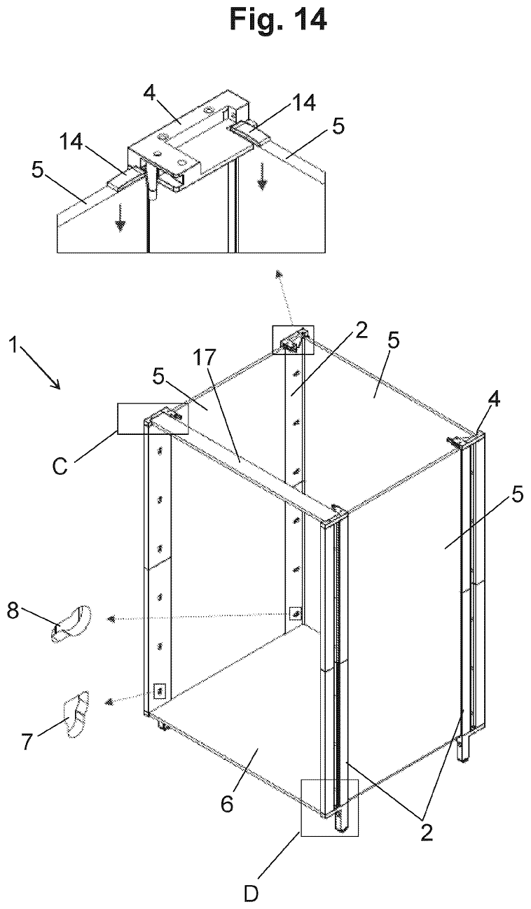

FIG. 14 shows different details of the body construction 1. It is evident that the second fastening devices 4 for connection to the cross member 17 are furthermore connected to positioning elements 14. These positioning elements 14 are designed to position the first surface elements 5 by pressing the surface elements 5 downwards by way of the positioning elements 14 designed as leaf spring elements, so that the first surface elements 5 are connected to the second surface element 6 or—more precisely: pressed against and/or pre-tensioned on the second surface element 6. The positioning element(s) 14 is or are formed by plastic springs injection-molded onto the second fastening device 4.

Furthermore, it is apparent that two of the at least four vertical supports 2 each have at least one first interface 7 for fastening at least one furniture fitting—to be precise: the pullout guide 9—and the other two of the at least four vertical supports 2 each have at least one second interface 8 for fastening the furniture fitting—the pullout guide 9—wherein the first interface 7 and the second interface 8 are designed differently—more precisely: the first interface 7 and the second interface 8 are arranged essentially rotated by 90° in relation to one another.

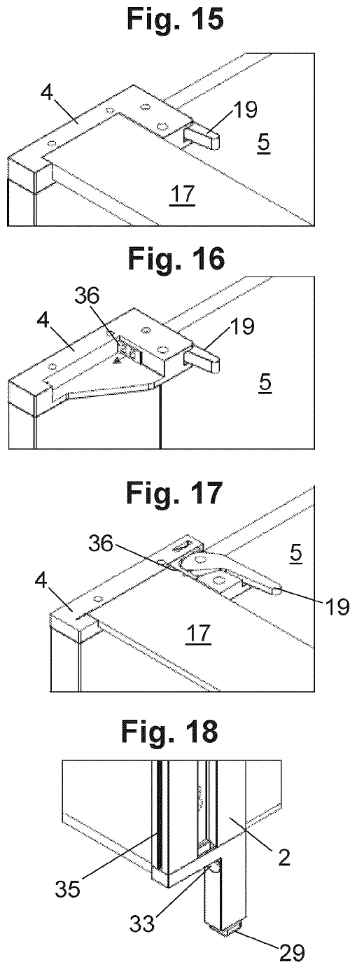

The detailed view C indicated by FIG. 14 is shown in FIGS. 15 to 17, which show a more detailed embodiment of the second fastening device 4 for fastening the cross member 17.

FIG. 15 shows a view of the second fastening device 4 in interaction with the cross member 17.

FIG. 17 shows a sectional view of FIG. 15 and FIG. 16 shows view C without cross member 17. It can be seen that the second fastening device 4 for tool-free fastening of the cross member 17 has a clamping device 18. This clamping device 18 can have an eccentrically mounted lever 19, wherein the holding structure 36 can be moved by a pivoting movement of the eccentrically mounted lever 19.

By way of this movement of the retaining structure 36, the retaining structure 36 provided with the protrusions can be brought towards or away from the surface of the cross member 17, due to which the retaining structure 36 can exert a clamping force on the cross member 17 with an opposing, corresponding surface of the fastening device to secure the position of the cross member 17 relative to the second fastening device 4. The surface corresponding to the holding device 36 can also be embodied having a holding structure having protrusions and depressions.

FIG. 18 shows detailed view B indicated in FIG. 14, wherein the already known foot 29 is again visible. However, the exemplary embodiment of FIG. 18 has, in contrast to the previous figures, a sealing lip 35 which is arranged on an end face of the vertical supports 2.

This sealing lip 35 can be designed to subsequently seal the drawers 10 pressing against the body construction 1. In this exemplary embodiment, the sealing lip 35 can, for example, be attached to the vertical support 2 via an adhesive bond, or it can also be provided that the vertical support 2 has a corresponding groove into which the sealing lip 35 is inserted.

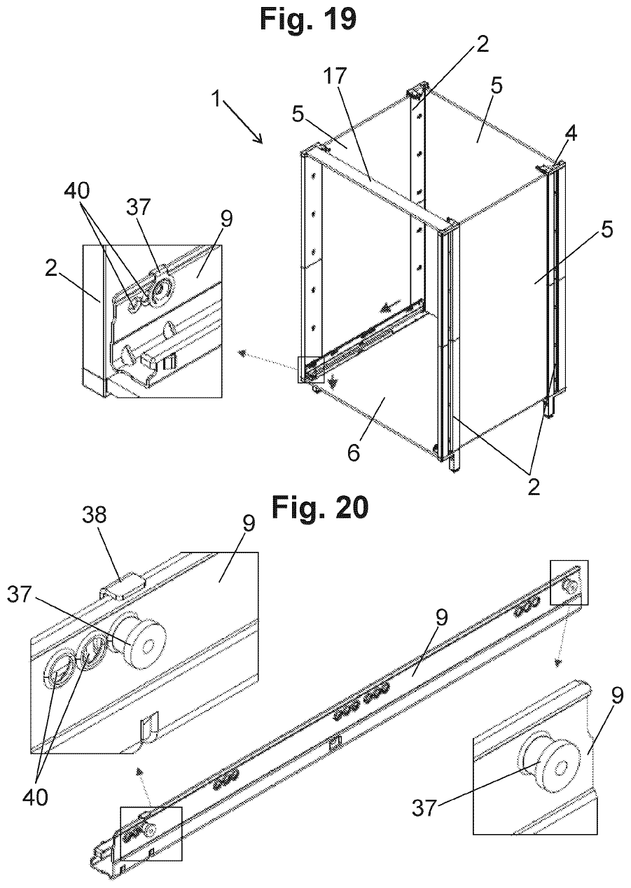

FIG. 19 shows a connection between the vertical supports 2 and the pullout guides 9. To accommodate the pullout guides 9, the vertical supports 2 have interfaces 7, 8, as can already be seen from FIG. 14. The pullout guides 9 (see the detailed view of FIG. 20) are equipped with connecting elements 27 to form a corresponding connection to the interfaces 7, 8. As indicated by the arrows in FIG. 19, in a first step the pullout guide 9 is inserted with its rear connecting element 37 into the second interface 8 and moved forward, due to which the connecting element 37 anchors itself in the second interface 8.

In a further step, the front connecting element 37 is inserted into the first interface 7 and anchored downwards, resulting in an exact positioning of the pullout guide 9 relative to the vertical support 2 and thus to the body construction 1. In addition, the pullout guide 9 has a locking element 38, which is implemented by a partially elastic construction.

This partially elastic construction of the locking element 38 engages in the upper geometry of the first interface 7 (see FIG. 14) after the front connecting element 37 engages in the first interface 7, by which the pull-out guide 9—more precisely: the front connecting element 37—is anchored in the first interface 7 in such a way that a movement upward is prevented, unless the locking element 38 is intentionally pulled out of the first interface 7 again.

Thus, the locking element 38 ensures that the pullout guide 9 on the vertical supports 2 is not changed in position by forces arising from the drawers 10 during the use and operation of the body construction 1, by which smooth operation of the pullout guide 9 is ensured. Furthermore, the fastening openings 40 are provided on the pullout guide 9. These fastening openings 40 can alternatively or additionally be used to connect the pullout guide 9 to a vertical support 2 by fastening means (for example, a screw connection).

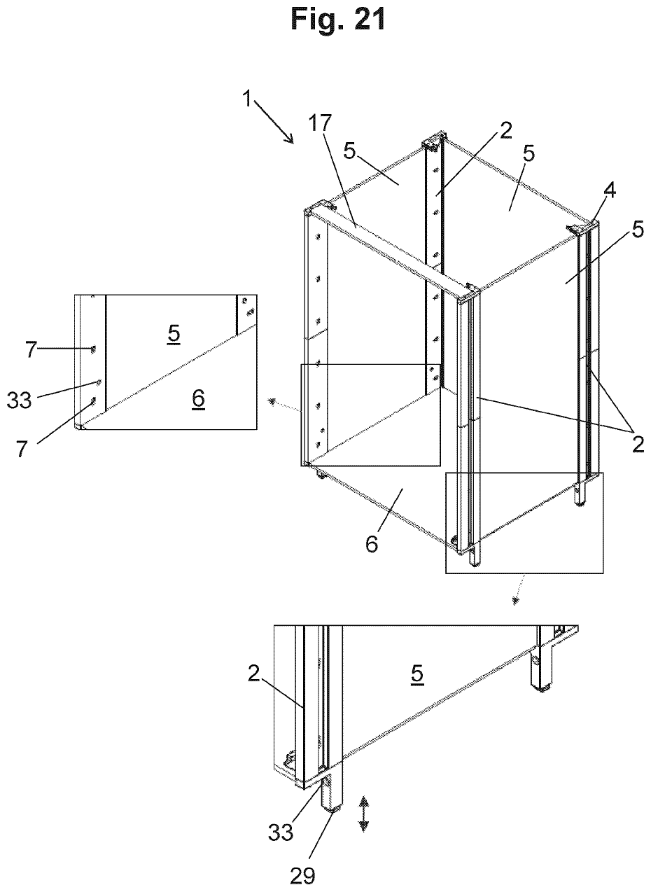

FIG. 21 shows another exemplary embodiment of a body construction 1, wherein this exemplary embodiment—more precisely: the detailed views shown—shows different positioning options for the adjustment element 33 for adjusting the height of the feet 29. Regarding the principle of height adjustment of the feet 29, reference is made to the preceding figures.

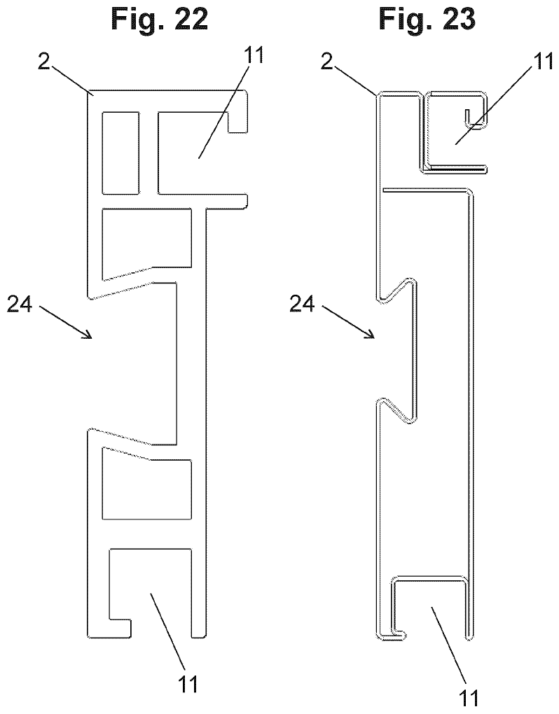

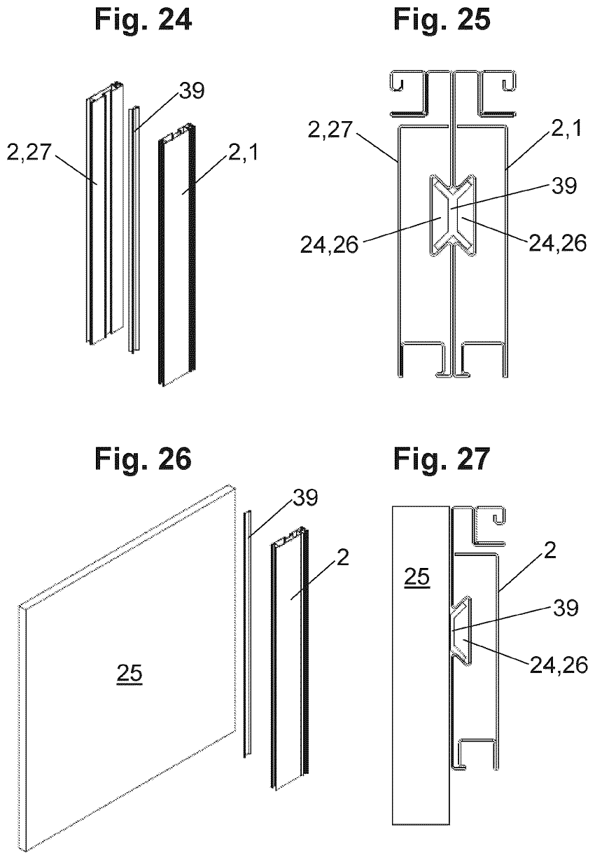

FIGS. 22 and 23 show a cross section of a vertical support 2, wherein it can be seen in the cross section that, for example, according to the embodiment of FIG. 22, the vertical support 2 can be designed as an aluminum extruded casting or as an extruded plastic part. However, it is also quite conceivable that the vertical support 2 can be designed as a component consisting of a sheet metal material—preferably a metal sheet material—according to the exemplary embodiment shown in FIG. 23. However, as can be seen from both embodiment variants of FIGS. 22 and 23, the vertical supports 2 have a connection interface 24 in addition to the already known components. The connection interface 24 is designed to connect the vertical support 2 to an outer cover element (see FIGS. 26 and 27) and/or to directly connect the vertical support 2 to a vertical support 2 of a further body construction 27 (see FIGS. 24 and 25).

For example, FIGS. 24 and 25 show how a vertical support 2 of the body construction 1 can be connected to another vertical support 2 of another body construction 27 with the aid of the connection interface 24. Thus, both vertical supports 2 have a connecting groove 26. The connecting element 39, which connects the two vertical supports 2 to one another, is then inserted into these connecting grooves 26.

FIGS. 28 and 29 show an exemplary embodiment of a connection interface 24 for connecting a vertical support to a cover plate 25. Such a cover plate 25 can be arranged on the body construction 1 to refine or design the external appearance of the body construction 1. For this purpose, the connection interface 24 on the vertical support 2 is formed by a connecting groove 26.

The connecting element 39 can be arranged on the cover element 25, for example, by way of an adhesive bond or screw connection, wherein the vertical support 2 can in turn be connected to the cover element 25 via the connecting element 39 and its arrangement in the connecting groove 26.

### List of Reference Numerals

1 body construction
2 vertical support
3 first fastening device
4 second fastening device
5 first surface element
6 second surface element
7 first interface
8 second interface
9 pull-out guide
10 drawer
11 groove
12 retaining element
13 barbed geometry
14 positioning element
15 spring element
16 engagement element
17 cross member
18 clamping device
19 lever
20 first end
21 second end
22 part
23 part
24 connection interface
25 cover element
26 connecting groove
27 body construction
28 worktop
29 foot
30 base body
31 actuating element
32 plug-in system
33 adjustment element
34 rotation bearing
35 sealing lip
36 support structure
37 connecting element
38 safety element
39 connecting element
40 fastening opening

1. An arrangement for assembling a body construction, in particular a base cabinet, the arrangement comprising:
at least four vertical supports, each comprising a first fastening device for tool-free assembly of at least one first surface element parallel to the vertical support, and at least one second fastening device for tool-free assembly of at least one second surface element transverse to the vertical support.

2. The arrangement according to claim 1, wherein the vertical supports each have at least one interface for, preferably tool-free, fastening of at least one furniture fitting, preferably a pullout guide for a drawer, preferably transversely to the vertical support.

3. The arrangement according to claim 2, wherein two of the at least four vertical supports each have at least one first interface for fastening at least one furniture fitting, and the other two of the at least four vertical supports each have at least one second interface for fastening at least one furniture fitting, wherein the first interface and the second interface are designed differently, preferably wherein the first interface and the second interface are arranged essentially rotated by 90° in relation to one another.

4. The arrangement according to claim 1, further comprising at least one furniture fitting, preferably a pullout guide for a drawer, the at least one furniture fitting:
is connected to at least one of the vertical supports by at least one fastening means, preferably which cooperates with a fastening opening of the furniture fitting, and/or
is connected to at least one of the vertical supports by at least one connecting element, preferably wherein the at least one connecting element engages in an interface of at least one of the vertical supports.

5. The arrangement according to claim 1, wherein the first fastening device and/or the second fastening device is or are releasably connectable to one of the vertical supports, preferably wherein the first fastening device and/or the second fastening device is or are connected to the vertical support by means of a formfitting and/or friction-locked connection, particularly preferably a screw and/or plug connection.

6. The arrangement according to claim 1, wherein the first fastening device comprises a groove along a longitudinal extension on at least one of the vertical supports, wherein the first surface element is positionable in the groove parallel to the vertical support.

7. The arrangement according to claim 1, wherein the first fastening device furthermore has a retaining element arranged in the groove, which retaining element is preferably formed by a formfitting connection, particularly preferably by a barbed geometry, to secure the first surface element positioned in the groove in the groove.

8. The arrangement according to claim 1, wherein the second fastening device has a positioning element for positioning the second surface element in relation to at least one of the vertical supports, preferably wherein the positioning element includes at least one spring element.

9. The arrangement according to claim 1, wherein the second fastening device has at least one engagement element, which engagement element is designed to engage in the second surface element for securing the position, preferably to implement a formfitting connection to the second surface element.

10. The arrangement according to claim 9, wherein the at least one engagement element has a tensioning element, preferably a spring element, which pre-tensions the engagement element in relation to the second surface element.

11. The arrangement according to claim 1, wherein at least two of the vertical supports each have a further second fastening device for fastening a cross member connecting the two vertical supports.

12. The arrangement according to claim 11, wherein the further second fastening device for tool-free fastening of the cross member has a clamping device, which clamping device is preferably designed to exert a clamping force on the cross member via an eccentrically mounted lever.

13. The arrangement according to claim 1, wherein a second fastening device is arranged or arrangeable in each case at a first end and an opposite second end of at least one vertical support, preferably wherein the two second fastening devices have a distinguishable design.

14. The arrangement according to claim 1, wherein at least one first fastening device is arranged or arrangeable on at least one longitudinal side of at least one vertical support.

15. The arrangement according to claim 1, wherein at least one, preferably all, of the vertical supports is or can be composed of at least two parts, preferably wherein the at least two parts are connectable to one another without tools.

16. The arrangement according to claim 1, wherein at least one, preferably all, of the vertical supports has at least one connection interface for connecting the vertical support to an outer cover element and/or for directly connecting the vertical support to a vertical support of a further body construction.

17. A body construction, in particular a base cabinet, which body construction is formed from the arrangement according to claim 1, wherein the at least four vertical supports are arranged essentially parallel to one another and on the vertical edges of a cuboid and are connected to one another via surface elements which are arranged parallel or transverse to the vertical supports.

18. The body construction according to claim 17, wherein each two adjacent vertical supports are connected to one another via at least one furniture fitting.

19. The body construction according to claim 17, wherein at least one, preferably all, of the provided surface elements is or are formed:
by essentially flat surface elements,
by a metal, plastic, and/or wooden material, preferably a chipboard, and/or
to have a wall thickness of 1 to 15 mm, preferably 5 to 13 mm, particularly preferably 7 to 10 mm.

20. A method for assembling a body construction, in particular of a base cabinet, by means of at least one arrangement according to claim 1, the method comprising:
connecting two of the at least four vertical supports to one another via at least one first surface element parallel to the vertical supports or via at least one second surface element transverse to the vertical supports, wherein in each case the at least one first surface element is installed on the vertical support without tools by means of the first fastening device or the at least one second surface element is installed on the vertical support without tools by means of the second fastening device, and
connecting the other two of the at least four vertical supports to the two previously connected vertical supports via further surface elements parallel or transverse to the vertical supports, so that the at least four vertical supports are arranged essentially parallel to one another and on the vertical edges of a cuboid.

21. The method according to claim 20, further comprising connecting in each case two adjacent vertical supports to one another via at least one furniture fitting, preferably a pullout guide for a drawer, preferably transversely to the vertical supports.
